(19) United States
(12) Patent Application Publication
(10) Pub. No.: US 2020/0244809 A1
(43) Pub. Date: Jul. 30, 2020

(54) METHOD OF AUTOMATICALLY PLAYING A VOICE MESSAGE, AND SMART PHONE AND COMPUTER PROGRAM PRODUCT IMPLEMENTING THE SAME

(71) Applicant: Letstalk Technology Limited, Taipei City (TW)

(72) Inventors: Chan-Guan KOH, Taipei City (TW); Chun-Hao CHEN, Taipei City (TW); Tzu-Ying WANG, Taipei City (TW); Sheng-Yen FANG, Taipei City (TW); Chien-Cheng LU, Taipei City (TW); I-Yun CHAO, Taipei City (TW)

(21) Appl. No.: 16/460,261

(22) Filed: Jul. 2, 2019

(30) Foreign Application Priority Data
Jan. 30, 2019 (TW) 108103458
Jan. 30, 2019 (TW) 108201453

(51) Int. Cl. H04M 3/533; H04L 12/58; H04W 4/02; H04M 1/60; H04W 4/12; H04W 4/16

(52) U.S. Cl. CPC H04M 3/5335; H04L 51/046; H04W 4/023; H04W 4/16; H04M 3/53375; H04W 4/12; H04M 1/605

(57) ABSTRACT

A method of automatically playing a voice message is proposed to be implemented by a smartphone that executes an instant communication software program. The method includes: opening, by the smartphone, a chat window for communication between a user of the smartphone and a chatting target; and upon determining that there is at least one voice message not having been played before in the chat window and, based on a signal provided by a proximity sensor near a receiver of the smartphone, that there is an object close to the receiver, automatically and audibly outputting the at least one voice message using the receiver.

### CROSS-REFERENCE TO RELATED APPLICATION

This application claims priorities of Taiwanese Invention Patent Application No. 108103458 and Taiwanese Utility Model Patent Application No. 108201453, both filed on Jan. 30, 2019.

### FIELD

The disclosure relates to a method of playing a voice message, and more particularly to a method of automatically playing a voice message via an instant communication software program.

### BACKGROUND

Nowadays, people may operate smartphones that execute an instant communication software program to create a chat window (also called a virtual chat room) to communicate with other users by instant communication. The chat window usually allows users to transmit text messages, sticker images, files, photos, hyperlinks, etc., to each other, and further allows users to record voice messages for other users in the chat window. When a user receives a voice message recorded by another user using a conventional instant communication software program, the smartphone of the user who received the voice message would show an icon representing the voice message and a playing option for playing the voice message. The user may tap the playing option on a touch screen of the smartphone to play the voice message via a receiver or a loudspeaker of the smartphone.

When there are multiple voice messages not having been played before, the user may need to tap the playing options respectively corresponding to the voice messages one by one so that the smartphone plays the voice messages accordingly. If there are a large number of voice messages to be played, it may be inconvenient and time-consuming for the user to manually operate playback of the voice messages in this manner.

### SUMMARY

Therefore, an object of the disclosure is to provide a method of automatically playing a voice message via a smartphone that executes an instant communication software program. The method may enable a user of the smartphone to listen to the voice message without additional manual operations.

The method includes: opening, by the smartphone, a chat window for communication between a user of the smartphone and a chatting target; and upon determining that there is at least one voice message not having been played before in the chat window and, based on a signal provided by a proximity sensor near a receiver of the smartphone, that there is an object close to the receiver, automatically and audibly outputting, by the smartphone, the at least one voice message using the receiver.

Another object of this disclosure is to provide a smartphone that implements the method of this disclosure. The smartphone is installed with an instant communication software program, and includes a receiver, a proximity sensor disposed near the receiver and configured to generate a signal in response to detection thereof, and a processing unit electrically coupled to the receiver and the proximity sensor. The processing unit is configured to, when executing the instant communication software program: open a chat window for communication between a user of the smartphone and a chatting target in response to user operation on the smartphone; and upon determining that there is at least one voice message not having been played before in the chat window and, based on the signal provided by the proximity sensor, that there is an object close to the receiver, automatically and audibly output the at least one voice message using the receiver.

Yet another object of this disclosure is to provide a computer program product that includes a non-volatile and tangible computer-accessible medium. The non-volatile and tangible computer-accessible medium includes an instant communication software program that, when loaded and executed by a smartphone including a receiver and a proximity sensor near the receiver, causes the smartphone to perform the method of this disclosure.

### BRIEF DESCRIPTION OF THE DRAWINGS

Other features and advantages of the disclosure will become apparent in the following detailed description of the embodiment(s) with reference to the accompanying drawings, of which:

FIG. 1 is a flow chart illustrating steps of a first embodiment of the method of automatically playing a voice message for a smartphone according to the disclosure;

FIG. 2 is a block diagram illustrating the smartphone;

FIG. 3 is a schematic diagram illustrating a chat window that is created by an instant communication software program executed by the smartphone, the chat window including several unplayed voice messages;

FIG. 4 is a schematic diagram illustrating the chat window, and one of the unplayed voice messages being played; and

FIG. 5 is a flow chart illustrating steps of a second embodiment of the method of automatically playing a voice message for a smartphone according to the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

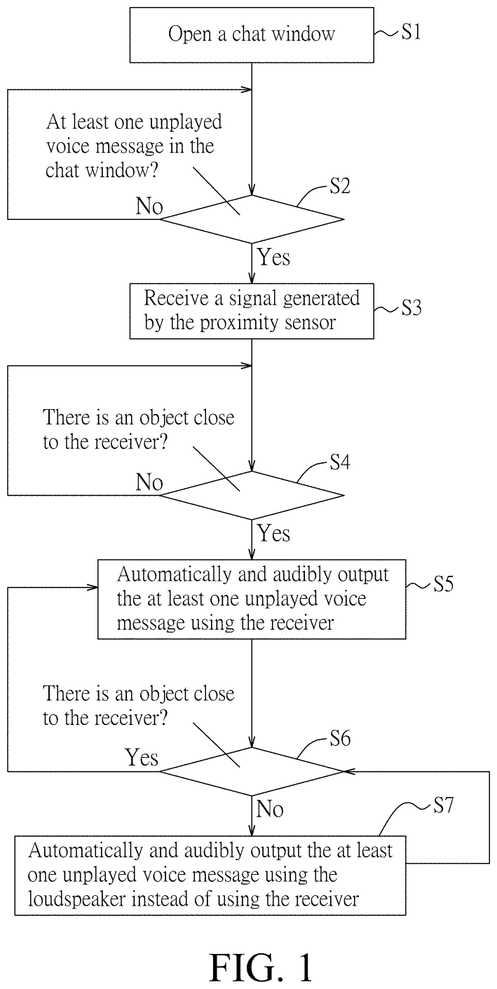

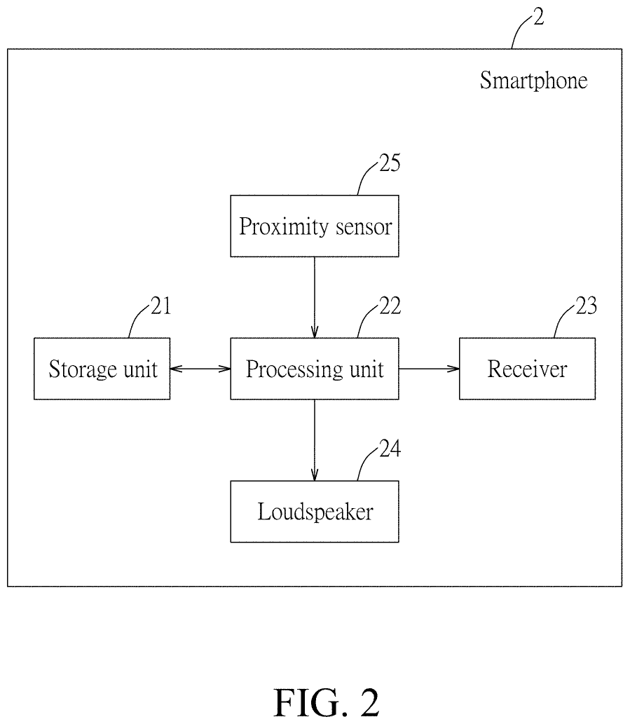

Referring to FIGS. 1 and 2, the first embodiment of the method of automatically playing a voice message according to this disclosure is implemented by a smartphone 2. In this embodiment, the smartphone 2 includes a storage unit 21 (e.g., a flash drive), a processing unit 22 (e.g., a smartphone processor), a receiver 23, a loudspeaker 24 to broadcast voices outputted by the smartphone 2, and a proximity sensor 25. The components 21, 23, 24, 25 are electrically coupled to the processing unit 22. The receiver 23 is a listening device for a user to listen to audio sound outputted by the smartphone 2 in a manner like using a traditional telephone, and is disposed at an upper side of a touch screen (not shown) of the smartphone 2. The loudspeaker 24 is disposed at a lower side of the touch screen in this embodiment, but this disclosure is not limited in this respect. The proximity sensor 25 is disposed near/proximate to the receiver 23 at, for example, a lateral side of the receiver 23, and is controlled by the processing unit 22 to detect presence of nearby objects and generate a signal in response to the detection thereof. The smartphone 2 implements the embodiment when the processing unit 22 executes an instant communication software program installed in the storage unit 21. In practice, the instant communication software program may be included/stored in a non-volatile and tangible computer-accessible medium (e.g., an optical disk, a hard disk drive, a flash drive, a solid state drive, or the like) and sold as a computer program product, and installed into the storage unit 21 after the user obtains authorization for installing the instant communication software program. When loaded and executed by the processing unit 22, the instant communication software program may cause the processing unit 22 to perform steps as illustrated in FIG. 1.

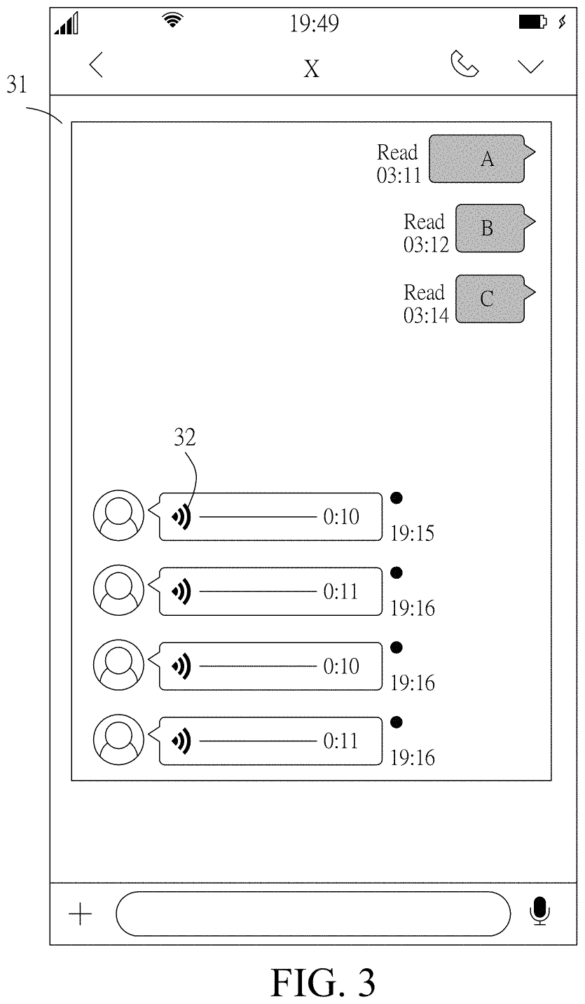

In step S1, the processing unit 22 executes the instant communication software program in response to user operation on the smartphone 2 to open a chat window 31 (also called a virtual chat room), which may be newly created or previously created by the instant communication software program, for communication with a chatting target (X), as shown in FIG. 3. At this time, the user may view the history of communication with the chatting target (X) from the chat window 31, where a right side of the chat window 31 exemplarily shows text messages directed to the chatting target (X) and sent from the user of the smartphone 2, and a left side of the chat window 31 exemplarily shows voice messages received from the chatting target (X). The voice messages may be generated by the chatting target (X) using a recording function of the instant communication software program, but this disclosure is not limited in this respect.

In step S2, the processing unit 22 determines whether there is, in the chat window 31, at least one voice message (provided by the chatting target (X)) not having been played before (a voice message that has not been played before may be referred to as an unplayed voice message hereinafter). In this embodiment, solid dots are used to indicate unplayed voice messages. As exemplified in FIG. 3, there are multiple (four in FIG. 3) voice messages that have not been played before and that correspond to different time points (e.g., time points at which the voice messages were received). It is noted that although three of the four voice messages correspond to “19:16” in FIG. 3, they actually correspond to different time points that can be distinguished in a smaller time scale, like seconds.

The flow goes to step S3 when the processing unit 22 determines that there is at least one voice message that has not been played before in the chat window 31, and repeats step S2 when otherwise.

In step S3, the processing unit 22 controls the proximity sensor 25 to proceed with detection of presence of nearby objects, and receives the signal generated and provided by the proximity sensor 25 in response to the detection of the proximity sensor 25.

In step S4, the processing unit 22 determines, based on the signal received from the proximity sensor 25, whether there is an object close to the receiver 23. The flow goes to step S5 when the processing unit 22 determines that there is an object close to the receiver 23 (although what is represented by the signal provided by the proximity sensor 25 is that the object is close to the proximity sensor 25). For example, when the user picks up the smartphone 2 and puts the receiver 23 by an ear, the processing unit 22 will determine that there is an object (i.e., the user's ear in this case) close to the receiver 23. Step S4 would be repeated when the processing unit 22 determines that there is no object close to the receiver 23. The repetition of step S4 continues until it is determined that there is an object close to the receiver 23 and the flow goes to step S5, or until the chat window 31 is closed by the user.

In step S5, the processing unit 22 causes the receiver 23 to automatically and audibly output the voice message(s) not having been played before. In the cases that there are multiple unplayed voice messages, these voice messages may be outputted in time sequence, a.k.a, the temporal order in which they were received (i.e., according to the time points to which the voice messages correspond) in some implementations. Hence, the user does not need to tap the unplayed voice messages on the smartphone 2, and theses voice messages would be automatically played and audibly outputted through the receiver 23 when the user puts the smartphone 2 near his/her ear. In the above-described situation, only the user can hear the voice message(s) being played.

In step S6, during the automatic audible output of the unplayed voice message(s) by the receiver 23, the processing unit 22 controls the proximity sensor 25 to continuously perform detection, and determines whether there is an object close to the receiver 23 based on the signal continuously provided by the proximity sensor 25. Upon determining that there is (still) an object close to the receiver 23, the flow goes back to step S5, where the processing unit 22 keeps on causing the receiver 23 to audibly output the unplayed voice message(s). Upon determining that there is no (longer an) object close to the receiver 23, the flow goes to step S7, where the processing unit 22 automatically causes the loudspeaker 24, instead of causing the receiver 23, to audibly output the unplayed voice message(s). That is, the component used to audibly output the unplayed voice message(s) is switched from the receiver 23 to the loudspeaker 24. For example, when the user intends to make others listen to the voice message that is currently being played, he or she only needs to bring the smartphone 2 away from his or her ear in order for the audible output of said voice message to switch from coming out of the receiver 23 to coming out of the loudspeaker 24 under control of the processing unit 22, so other people can hear.

During the automatic audible output of the unplayed voice message(s) by the loudspeaker 24, the processing unit 22 continuously performs step S6, i.e., controlling the proximity sensor 25 to continuously perform detection, and determining whether there is an object close to the receiver 23 based on the signal continuously provided by the proximity sensor 25. Upon determining that there is an object close to the receiver 23, the flow goes back to step S5, i.e., the voice message that is being played will be switched by the processing unit 22 from being outputted by the loudspeaker 24 back to being outputted by the receiver 23. Otherwise, the flow stays in step S7, where the processing unit 22 continues to cause the loudspeaker 24 to audibly output the unplayed message(s). Steps S5 to S7 are continuously repeated until all the unplayed voice message(s) is(are) played, or until the processing unit 22 receives an instruction to stop or pause playing.

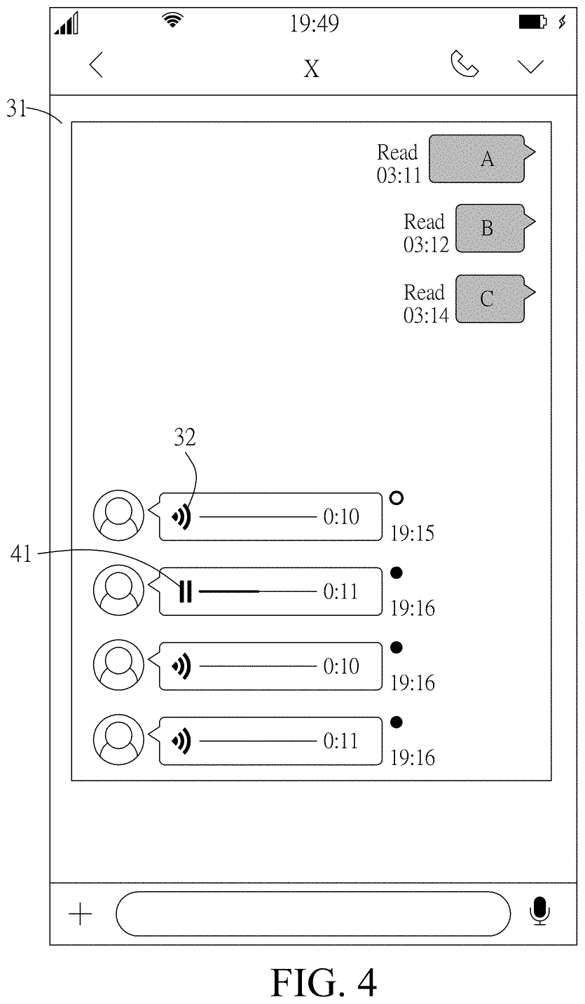

FIG. 4 exemplarily illustrates a condition where the first voice message has been played (corresponding to a hollow dot), and playing of the second voice message is in progress. At this time, if the user taps a pause icon 41 on the touch screen of the smartphone 2 so that the instruction to pause playing is generated and provided to the processing unit 22, the processing unit 22 would stop outputting the second voice message.

In the case that the playing of the second voice message is terminated or paused when the second voice message has not been played in its full, the processing unit 22 would still treat the second voice message as an unplayed voice message, and the flow goes to step S2 if the chat window 31 is still opened. Accordingly, when the user puts the smartphone 2 by the ear again so that the processing unit 22 determines that there is an object close to the receiver 23 based on the signal provided by the proximity sensor 25, the processing unit 22 will automatically cause the receiver 23 to audibly output the second voice message and all subsequent unplayed message(s) (if any) from the beginning of the second voice message (in the case that the playing of the second voice message was terminated) or from the beginning of the unplayed part (in the case that the playing of the second voice message was paused). In some implementations, even if the playing of the second voice message is paused, the second voice message may be replayed from the beginning, and this disclosure is not limited in this respect.

It is noted that, although the multiple unplayed voice messages are exemplified to follow one after the other in FIGS. 3 and 4, this disclosure is not limited in this respect. In practice, there may be other non-voice messages (e.g., text messages, sticker images, photo images, etc.) inserted between or among the multiple unplayed voice messages, but this will not have any impact on the execution of the embodiment. As long as the processing unit 22 determines that there is at least one unplayed voice message in the chat window 31 and that there is an object close to the receiver 23, the processing unit 22 will automatically and audibly output the unplayed voice message(s) through the receiver 23.

In addition, the smartphone 2 can still be manually operated to play the voice messages. Referring to FIG. 3 again, the user may still tap a play icon 32 corresponding to the desired voice message (regardless of whether it has been played before or not) on the touch screen of the smartphone 2, so as to generate an instruction for playing the desired voice message to trigger the processing unit 22 to audibly output the desired voice message through the loudspeaker 24.

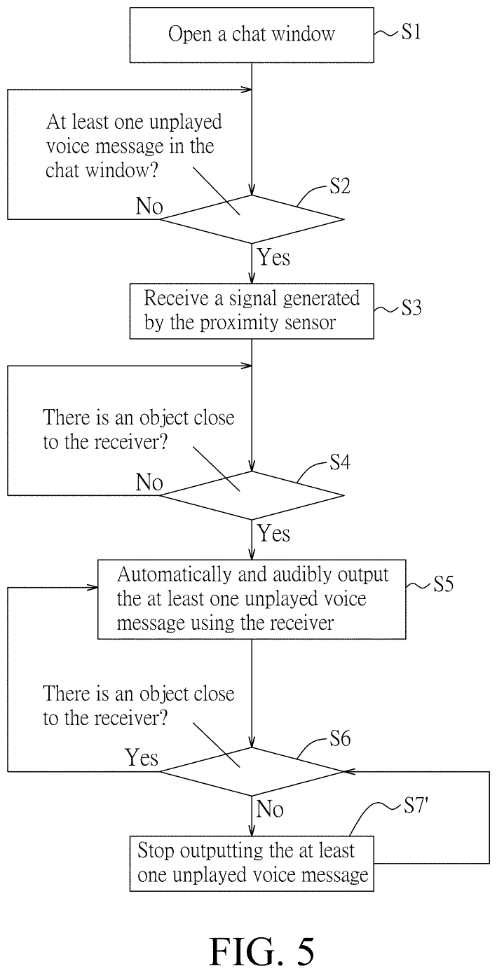

FIG. 5 illustrates the second embodiment of the method of automatically playing a voice message according to this disclosure. The second embodiment includes steps S1 to S6 that are the same as those of the first embodiment, and step S7′ that replaces step S7 of the first embodiment. In the second embodiment, when the processing unit 22 determines that there is no object close to the receiver 23 in step S6, the flow goes to step S7′ where the processing unit 22 stops the automatic audible output of the voice message(s), and the step goes back to step S2. Taking FIG. 4 as an example, during the automatic audible output of the second voice message by the receiver 23 (step S5), when the processing unit 22 determines (step S6), based on the signal from the proximity sensor 25, that there is no object close to the receiver 23 (e.g., the user takes the smartphone 2 away from the ear), the processing unit 22 stops playing the second voice message (step S7′), and the flow goes back to step S2. Upon determining that there is an object close to the receiver 23 again (affirmative in step S4) (e.g., the user puts the smartphone 2 by the ear again), the processing unit 22 automatically causes the receiver 23 to audibly output the second voice message and subsequent unplayed voice messages (if any) from the beginning of the second voice message or from the beginning of the unplayed part of the second voice message (i.e., from a time point at which the playing of the second voice message was interrupted).

In summary, the embodiments of this disclosure use the signal generated by the proximity sensor 25 to determine whether there is an object close to the receiver 23 of the smartphone 2, so as to determine whether to automatically and audibly output the unplayed voice message(s) in the chat window 31 through the receiver 23. During the automatic audible output of the unplayed voice message(s), the processing unit 22 continues to determine whether there is an object close to the receiver 23, so as to determine whether to use the loudspeaker 24 to play the unplayed voice message(s) instead or to stop output of the unplayed voice message (s). Accordingly, the user is not required to use an additional manual operation (such as tapping) in order to listen to the unplayed voice message(s), and can listen to the unplayed message(s) by simply putting the smartphone 2 by the ear or moving the smartphone 2 away from the ear to activate automatic output of the unplayed voice message (s) by the receiver 23 or the loudspeaker 24 (the first embodiment), achieving a convenient and time-saving operation for the user to listen to the unplayed voice message(s).

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

1. A method of automatically playing a voice message, implemented by a smartphone that executes an instant communication software program, said method comprising:
opening a chat window for communication between a user of the smartphone and a chatting target; and
immediately after determining that there is at least one voice message not having been played before in the chat window and, based on a signal provided by a proximity sensor near a receiver of the smartphone, that there is an object close to the receiver, automatically and audibly outputting the at least one voice message using the receiver.

2. The method of claim 1, wherein the at least one voice message includes multiple voice messages not having been played before, the multiple voice messages corresponding to different time points; and
wherein the automatically and audibly outputting the at least one voice message using the receiver includes automatically and audibly outputting the multiple voice messages in time sequence.

3. The method of claim 1, further comprising:
during the automatic audible output of the at least one voice message using the receiver, continuously determining whether there is an object close to the receiver based on the signal continuously provided by the proximity sensor; and
upon determining that there is no object close to the receiver during the automatic audible output of the at least one voice message using the receiver, automatically and audibly outputting the at least one voice message using a loudspeaker thereof instead of using the receiver.

4. The method of claim 3, further comprising:
during the automatic audible output of the at least one voice message using the loudspeaker, continuously determining whether there is an object close to the receiver based on the signal continuously provided by the proximity sensor; and
upon determining that there is an object close to the receiver during the automatic audible output of the at least one voice message using the loudspeaker, automatically and audibly outputting the at least one voice message using the receiver instead of using the loudspeaker.

5. The method of claim 1, further comprising:
during the automatic audible output of the at least one voice message using the receiver, continuously determining whether there is an object close to the receiver based on the signal continuously provided by the proximity sensor; and
upon determining that there is no object close to the receiver during the automatic audible output of the at least one voice message using the receiver, stopping the automatic audible output of the at least one voice message.

6. A smartphone installed with an instant communication software program, comprising:
a receiver;
a proximity sensor disposed near the receiver, and configured to generate a signal in response to detection thereof, and
a processing unit electrically coupled to said receiver and said proximity sensor, and configured to, when executing the instant communication software program:
open a chat window for communication between a user of said smartphone and a chatting target in response to user operation on said smartphone; and
immediately after determining that there is at least one voice message not having been played before in the chat window and, based on the signal provided by said proximity sensor, that there is an object close to said receiver, automatically and audibly output the at least one voice message using said receiver.

7. The smartphone of claim 6, wherein the at least one voice message includes multiple voice messages not having been played before, the multiple voice messages corresponding to different time points; and
wherein said processing unit is configured to, when executing the instant communication software program, use said receiver to automatically and audibly output the multiple voice messages in time sequence upon determining that there is at least one voice message not having been played before in the chat window and that there is an object close to said receiver.

8. The smartphone of claim 6, further comprising a loudspeaker electrically coupled to said processing unit;
wherein said processing unit is further configured to, when executing the instant communication software program:
during the automatic audible output of the at least one voice message using said receiver, continuously determine whether there is an object close to said receiver based on the signal continuously provided by said proximity sensor; and
upon determining that there is no object close to said receiver during the automatic audible output of the at least one voice message using said receiver, automatically and audibly output the at least one voice message using said loudspeaker instead of using said receiver.

9. The smartphone of claim 8, wherein said processing unit is further configured to, when executing the instant communication software program:
during the automatic audible output of the at least one voice message using said loudspeaker, continuously determine whether there is an object close to said receiver based on the signal continuously provided by said proximity sensor; and
upon determining that there is no object close to said receiver during the automatic audible output of the at least one voice message using said loudspeaker, automatically and audibly output the at least one voice message using said receiver instead of using said loudspeaker.

10. The smartphone of claim 6, wherein said processing unit is further configured to, when executing the instant communication software program:
during the automatic audible output of the at least one voice message using said receiver, continuously determine whether there is an object close to said receiver based on the signal continuously provided by said proximity sensor; and
upon determining that there is no object close to said receiver during the automatic audible output of the at least one voice message using said receiver, stop the automatic audible output of the at least one voice message.

11. A computer program product, comprising a non-volatile and tangible computer-accessible medium that includes an instant communication software program that, when loaded and executed by a smartphone including a receiver and a proximity sensor near the receiver, causes the smartphone to perform the method of claim 1.
